(19) United States
(12) Patent Application Publication
(10) Pub. No.: US 2004/0122913 A1
(43) Pub. Date: Jun. 24, 2004

(54) Method and design for data output/file output in communication networks, as well as a relevant computer program product and relevant computer readable storage medium

(75) Inventor: Carsten Mickeleit, Berlin (DE)

Correspondence Address: Norris, McLaughlin & Marcus P.A., 30th Floor, 220 East 42nd Street, New York, NY, 10017, US

(73) Assignee: ThinPrint GmbH, Berlin (DE)

(21) Appl. No.: 10/683,691

(22) Filed: Oct. 10, 2003

(30) Foreign Application Priority Data
Oct. 14, 2002 (DE) 102 48 528.3

(51) Int. Cl. G06F 15/16

(52) U.S. Cl. 709/217; 709/246

(57) ABSTRACT

The invention concerns a method for direct or indirect data output/file output in communication networks, as well as a relevant computer program product and a relevant computer readable storage medium that are particularly applicable to display and/or print contents from the internet, and intranet, or other storage medium on an end device.

It is also presumed that an end device transmits at least the information necessary for accessing data/files intended for output (contents) to a data processing unit, that the data processing unit, controlled by a computer program, opens the data/files intended for output at their respective storage location, starts a print job for issuing the data/files, and embeds the print file resulting from the print job in a hypertext page, particularly a HTML or WML site. This hypertext page or the print file or the contents are then provided for recall in the communication network and the information necessary for accessing the provided data/files is sent to the end device. The end device subsequently automatically recalls the content from the communication network and issues it. Alternatively, the contents can be requested and issued by manual recall.

The invention relates to a method for direct or indirect data output/file output in communication networks, as well as a relevant computer program product and a relevant computer readable storage medium, which are in particular applicable for displaying and/or printing content from the internet, and intranet, or other storage medium via an end device.

In the past, the internet was accessed mainly via stationary end devices, i.e. personal computers and similar, so that the presentation of content, such as documents, image files, etc., which had been downloaded from the internet, had no device-related limits because these end devices have sufficiently large screens, complex operating systems that can execute a multitude of applications, high memory capacity that enables storage of many applications and processing of files of any size.

Meantime within the context of technical development, the internet is increasingly accessed via mobile end devices such as mobile telephones, handheld computers, laptops, and pocket PCs. These mobile end devices-in contrast to stationary devices—have very small screens, minimal operating systems (WindowsCE, Palm, EPOC/Symbian, etc.), minimal versions of applications adapted for minimal operating systems, low working memory that only allows the processing of small files, and low memory capacity that only allows provision of a selection of applications.

Thus not all files or file formats and/or contents can be issued intelligently or issued at all. This concerns visual output on the display as well as printing the content. For this reason, besides the internet standard HTML, the WAP standard with its WML language was developed. Based on this WAP standard, a limited form of internet access via mobile devices is possible. However, HTML and WML can only communicate documents that have been created in these languages to the mobile end device.

As solution to this problem it has been suggested, among other things, to convert the relevant files to minimal format to bring them to display on the mobile end device. This conversion is nevertheless conducted manually and offline so that its use is extremely limited.

However, even stationary devices are not always capable of displaying relevant content in an appropriate way, if the necessary application is not installed on them for interpreting the data, insufficient working memory is available for loading the data, or an operating system is available on which the application cannot be executed, for example a Windows application on Unix.

The technology of mobile communication has asserted itself with the standard GSM and will continue to develop with the standards GPRS and HSCSD as well as the future UMTS. Thus the transmission options are continually optimized; i.e., the transmittable data amount increases drastically, whereas the options for issuing the content remain limited.

In the same way, the display of content from the internet, an intranet, or other storage medium which can be accessed from said type of end device is limited.

It is thus the object of the invention to provide a method and a design for data output/file output in communication networks, as well as a relevant computer program product and a relevant computer readable storage medium, which eliminate the above disadvantages and in particular allow content output that is independent of formats and applications.

This object is resolved according to the invention with the features in claim 1 and claims 14 to 16. Practical embodiments of the invention are included in the sub-claims.

It is for this purpose presumed that an end device transmits to a data processing unit at least the information necessary for accessing data/files intended for output; that the data processing unit, controlled by a computer program, opens the data/files intended for output at their respective storage location, starts a print job for issuing the data/files, and embeds the print file resulting from the print job in a hypertext page, particularly a HTML or WML site, and/or converts the data/files intended for output into a pre-specifiable format, and transmits the hypertext page containing the print file and/or the print file resulting from the print job and/or the, converted where necessary, data/files to the end device and the end device issues the transmitted data/files; or provides the hypertext page containing the print file and/or the print file resulting from the print job and/or the, converted where necessary, data/files for recall in the communication network and transmits to the end device the information necessary for accessing the provided information and the end device, after transmission of the information necessary for access, automatically recalls and issues the data/files from the communication network or the data/files intended for output are requested by manual recall and issued.

A design for data output/file output in communication networks is advantageously so constructed that it includes at least one processor and/or chip that is (are) so constructed that a method for data output/file output in communication networks is executable, that an end device transmits to the data processing unit at least the information necessary for accessing data/files intended for output, that the data processing unit, controlled by a computer program, opens the data/files intended for output at their respective storage location, starts a print job for issuing the data/files, and embeds the print file resulting from the print job in a hypertext page, particularly a HTML or WML site, and/or converts the data/files intended for output into a pre-specifiable format, and transmits the hypertext page containing the print file and/or the print file resulting from the print job and/or the, converted where necessary, data/files to the end device and the end device issues the transmitted data/files; or provides the hypertext page containing the print file and/or the print file resulting from the print job and/or the, converted where necessary, data/files for recall in the communication network and transmits to the end device the information necessary for accessing the provided information and the end device, after transmission of the information necessary for access, automatically recalls and issues the data/files from the communication network or the data/files intended for output are requested by manual recall and issued.

A computer program product for data output/file output in communication networks comprises a computer readable storage medium on which a program is stored that, once it has been loaded onto a computer's memory, enables the computer to perform a method for data output/file output in communication networks, by which an end device transmits to a data processing unit at least the information necessary for accessing the data/files intended for output; the data processing unit, controlled by a computer program, opens the data/files intended for output at their respective storage location, starts a print job for issuing the data/files, and embeds the print file resulting from the print job in a hypertext page, particularly a HTML or WML site, and/or converts the data/files intended for output into a pre-specifiable format, and transmits the hypertext page containing the print file and/or the print file resulting from the print job and/or the, converted where necessary, data/files to the end device and the end device issues the transmitted data/files; or provides the hypertext page containing the print file and/or the print file resulting from the print job and/or the, converted where necessary, data/files for recall in the communication network and transmits to the end device the information necessary for accessing the provided information and the end device, after transmission of the information necessary for access, automatically recalls and issues the data/files from the communication network or the data/files intended for output are requested by manual recall and issued.

To perform data output/file output, advantageously a computer readable storage medium is used, on which a program is saved that, once it has been loaded onto a computer's memory, enables the computer to perform a method for data output/file output in communication networks, by which an end device transmits to a data processing unit at least the information necessary for accessing the data/files intended for output; the data processing unit, controlled by a computer program, opens the data/files intended for output at their respective storage location, starts a print job for issuing the data/files, and embeds the print file resulting from the print job in a hypertext page, particularly a HTML or WML site, and/or converts the data/files intended for output into a pre-specifiable format, and transmits the hypertext page containing the print file and/or the print file resulting from the print job and/or the, converted where necessary, data/files to the end device and the end device issues the transmitted data/files; or provides the hypertext page containing the print file and/or the print file resulting from the print job and/or the, converted where necessary, data/files for recall in the communication network and transmits to the end device the information necessary for accessing the provided information and the end device, after transmission of the information necessary for access, automatically recalls and issues the data/files from the communication network or the data/files intended for output are requested by manual recall and issued.

In the following, content is understood as files and data that can be visualized and issued by using application programs. This content can be found in communication networks like internet, intranet—i.e., the network environment of a company-, or other storage medium—like central servers or standalone office computers. Data transmission can thereby be conducted over communication lines, over radio link or infrared transmission as well as a combination of these transmission options.

The address of the content is as a rule a so-called URL (Unified Resource Locator; e.g.,

http://www.thinprint.com/inhalt.doc, also called a link), a path name (C:\Dokumente\inhalt.doc) or an unambiguous description (information about a customer with the customer number 1234). All of these forms of address can also be offered to the user of the end device in prepared form.

The end device is preferably a mobile end device such as mobile telephone, handheld computer, laptop, and pocket PC or similar. It hereby also concerns stationary end devices like computers that, as previously described, are not always suitable for displaying every content, whereby in the latter case, the cause lies in the multitude of diverse applications used, which as a rule are not all available on a computer.

The data processing unit is as a rule a high-performance stationary computer or similar. It is, however, also conceivable that mobile end devices are used, insofar as these are appropriately equipped.

The interface can be a conventional cable interface, infrared or Bluetooth interface, or similar.

The address of the content intended for display is preferably sent to the data processing unit via a dialup connection or the internet, whereby the data processing unit could be a computer that is in the user's home or office, a corporate server, or the server of an internet service provider who wants to offer this service.

If the end device or mobile end device is not itself capable of displaying the content onscreen or issuing it, the method provides that all descriptions necessary for loading the desired contents onto a data processing unit are sent from the end device to the data processing unit. As a rule it is sufficient to send the relevant URL or the exact storage location. From the data processing unit, the content is subsequently loaded and then a print process and/or print job is started or, if necessary, the content is converted to a specific format. This format can be globally pre-specified, approximately set fixedly with the computer program implemented according to the invention on the data processing unit so that the conversion is performed independently from the requesting end device. It has been proved practical, for example, to embed the print files and/or the converted content in a HTML or WML site. An alternative to this that has also been proven practical is to convert the content into HTML files (or comparable formats), whereby the print view of the content is transmitted as unchanged as possible by the conversion. Thus created HTML files are then stored in the communication network or in the internet by the computer program implemented on the data processing unit and the relevant address (URL) is sent to the requesting end device.

Transmission of the necessary descriptions and/or addresses can also be performed in a different manner:

For example, within an internet session—regardless of whether HTML or WAP based—the user can be presented with possible content whose description is transmitted by selection, or the user enters the description directly in a field intended for that purpose. These descriptions are then also forwarded from the web server. The result, i.e. the document view, embedded in a HTML or WAP page, is displayed as direct response page to this action and therefore need not be called up again. To the user it seems as if he had simply clicked a link.

A further form of execution provides that transmission of the content is realized as follows: The user sends a mail, whose attachment he cannot open due to the reasons described, to the data processing unit, from which he then receives a response mail that contains the link to the result instead of the original document.

In another embodiment, transmission of the relevant address (URL) can also be performed as SMS, whereby the user subsequently accesses the entered network address manually, or the data transmitted by the data processing unit starts a program installed on the end device that automatically accesses the entered network address and issues, saves, and/or prints the content on the end device.

The use of HTML formats and storage in the internet has the advantage that most end devices, including mobile telephones, handheld computers, laptops, and pocket PCs, can access the internet without additional, specific software.

In addition, however, in an alternative form of execution of the invention, a desired output format can also be pre-specified from the end device, in which the content is to be converted by the computer program on the data processing unit. The associated descriptions can thereby either be transmitted from the end device to the data processing unit together with the access descriptions for the requested content or these format descriptions are stored together with other user descriptions on the data processing unit.

Of course the method according to the invention can be combined with other output systems. Thus parallel to storing the content in the communication net—or as alternative to it—a bitmap file can be created and sent to the first end device, because as a rule bitmap files can be issued from every end device with graphic display capability.

To keep the data amount to be transmitted from the data processing unit to the end device as small as possible, the (mobile) end device can also send its display information, e.g. display size, necessary scaling, color or black-and-white display, to the data processing unit along with the descriptions for loading the content. The data processing unit then creates from the requested content a bitmap file which suffice for the specific requirements so that only the truly necessary data amount is transmitted.

In some cases it could also prove to be intelligent not to create a HTML or WML file from the requested contents, but rather pure text files (for example, an ASCII file) that are then sent to the end device, because these can be displayed by most end devices.

The invention is not limited to the examples of execution described here. It is much more possible to realize further variants of execution by combining and modifying the described methods and features without leaving the context of the invention.

1. Method for data output/file output in communication networks,
thereby characterized that
an end device transmits to a data processing unit at least the information necessary for accessing the data/files intended for output; the data processing unit, controlled by a computer program, opens the data/files intended for output at their respective storage location, starts a print job for issuing the data/files, and embeds the print file resulting from the print job in a hypertext page, particularly a HTML or WML site, and/or converts the data/files intended for output into a pre-specifiable format, and
transmits the hypertext page containing the print file and/or the print file resulting from the print job and/or the, converted where necessary, data/files to the end device and the end device issues the transmitted data/files, or
provides the hypertext page containing the print file and/or the print file resulting from the print job and/or the, converted where necessary, data/files for recall in the communication network and transmits to the end device the information necessary for accessing the provided information and the end device, after transmission of the information necessary for access, automatically recalls and issues the data/files from the communication network or the data/files intended for output are requested by manual recall and issued.

2. Method according to claim 1,
thereby characterized that
the end device is a mobile end device.

3. Method according to claim 2,
thereby characterized that
the mobile end device is a mobile telephone, handheld computer, laptop or pocket PC.

4. Method according to claim 1,
thereby characterized that
the end device is a stationary end device.

5. Method according to one of the claims 1 to 4,
thereby characterized that
the data processing unit is a mobile end device.

6. Method according to claim 5,
thereby characterized that
the mobile end device is a mobile telephone, handheld computer, laptop or pocket PC.

7. Method according to one of the claims 1 to 6,
thereby characterized that
the information necessary for accessing data/files intended for output is transmitted from the end device to the data processing unit via a dialup connection or the internet.

8. Method according to one of the claims 1 to 7,
thereby characterized that
the information necessary for accessing data/files intended for output is transmitted from the end device to the data processing unit via SMS.

9. Method according to one of the claims 1 to 8,
thereby characterized that
besides the information necessary for accessing data/files intended for output, the end device additionally transmits display information and/or information about the pre-specifiable output format of the data/files to the data processing unit and the data processing unit creates from the data/files intended for output a bitmap file that suffices for the specific requirements of the end device's display.

10. Method according to claim 9,
thereby characterized that
the display information includes the size of the display, the necessary scaling, and/or input for either color or black-and-white display.

11. Method according to one of the claims 1 to 10,
thereby characterized that
the pre-specifiable format and/or the display information is stored according to user on the data processing unit.

12. Method according to one of the claims 1 to 11,
thereby characterized that
the data processing unit creates a pure text file from the data/files intended for output.

13. Method according to one of the claims 1 to 12,
thereby characterized that
the descriptions necessary for accessing the data/files provided for recall in the communication network are transmitted from the data processing unit to the end device by email or SMS.

14. Design with at least one processor and/or chip that is (are) so constructed that a method for data output/file output in communication networks is executable, that an end device transmits to the data processing unit at least the information necessary for accessing data/files intended for output, that the data processing unit, controlled by a computer program, opens the data/files intended for output at their respective storage location, starts a print job for issuing the data/files, and embeds the print file resulting from the print job in a hypertext page, particularly a HTML or WML site, and/or converts the data/files intended for output into a pre-specifiable format, and
transmits the hypertext page containing the print file and/or the print file resulting from the print job and/or the, converted where necessary, data/files to the end device and the end device issues the transmitted data/files; or
provides the hypertext page containing the print file and/or the print file resulting from the print job and/or the, converted where necessary, data/files for recall in the communication network and transmits to the end device the information necessary for accessing the provided information and the end device, after transmission of the information necessary for access, automatically recalls and issues the data/files from the communication network or the data/files intended for output are requested by manual recall and issued.

15. Computer program product that comprises a computer readable storage medium on which a program is stored that, once it has been loaded onto a computer's memory, enables the computer to perform a method for data output/file output in communication networks, by which an end device transmits to a data processing unit at least the information necessary for accessing the data/files intended for output, that the data processing unit, controlled by a computer program, opens the data/files intended for output at their respective storage location, starts a print job for issuing the data/files, and embeds the print file resulting from the print job in a hypertext page, particularly a HTML or WML site, and/or converts the data/files intended for output into a pre-specifiable format, and
transmits the hypertext page containing the print file and/or the print file resulting from the print job and/or the, converted where necessary, data/files to the end device and the end device issues the transmitted data/files; or
provides the hypertext page containing the print file and/or the print file resulting from the print job and/or the, converted where necessary, data/files for recall in the communication network and transmits to the end device the information necessary for accessing the provided information and the end device, after transmission of the information necessary for access, automatically recalls and issues the data/files from the communication network or the data/files intended for output are requested by manual recall and issued.

16. Computer readable storage medium on which a program is stored once it has been loaded onto a computer's memory, enables the computer to perform a method for data output/file output in communication networks, by which an end device transmits to a data processing unit at least the information necessary for accessing the data/files intended for output, that the data processing unit, controlled by a computer program, opens the data/files intended for output at their respective storage location, starts a print job for issuing the data/files, and embeds the print file resulting from the print job in a hypertext page, particularly a HTML or WML site, and/or converts the data/files intended for output into a pre-specifiable format, and
transmits the hypertext page containing the print file and/or the print file resulting from the print job and/or the, converted where necessary, data/files to the end device and the end device issues the transmitted data/files; or
provides the hypertext page containing the print file and/or the print file resulting from the print job and/or the, converted where necessary, data/files for recall in the communication network and transmits to the end device the information necessary for accessing the provided information and the end device, after transmission of the information necessary for access, automatically recalls and issues the data/files from the communication network or the data/files intended for output are requested by manual recall and issued.
